(19) United States
(12) Patent Application Publication
(10) Pub. No.: US 2001/0009400 A1
(43) Pub. Date: Jul. 26, 2001

(54) Indicator lamp

(76) Inventors: Shozo Maeno, Tokyo (JP); Katsuhito Yamaguchi, Tokyo (JP)

Correspondence Address: BIRCH STEWART KOLASCH & BIRCH, PO BOX 747, FALLS CHURCH, VA, 22040-0747, US

(21) Appl. No.: 09/761,591

(22) Filed: Jan. 18, 2001

(30) Foreign Application Priority Data
Jan. 25, 2000 (JP) 18037/2000

(51) Int. Cl. G08B 3/00

(52) U.S. Cl. 340/815.4; 340/693.9; 340/691.1; 361/748

(57) ABSTRACT

An indicator lamp has a structure that allows the indicator lamp to be reliably mounted on a printed-wiring board and permits soldering check to be performed easily. The indicator lamp has an electric light bulb and lead wires led out from the light bulb. The lead wires are soldered to respective patterns on a printed-wiring board. The leading end portions of the lead wires are looped.

### BACKGROUND OF THE INVENTION

1. Field of the Invention

The present invention relates to an indicator lamp for use in automobiles or other vehicles.

2. Discussion of Related Art

Indicator lamps are incorporated in car components such as an air conditioner, a car stereo, etc. installed in automobiles or other vehicles to indicate the operating status of the associated components. Indicator lamps are also incorporated in an instrument panel accommodating various gages to indicate the operating status of the associated devices.

FIGS. 6(a), 6(b), 6(c) and 7 show a conventional indicator lamp 1. The indicator lamp 1 has an electric light bulb 2 in a transparent housing 3. The light bulb 2 contains a filament. A pair of lead wires 4 are led out from the bottom of the light bulb 2 to supply electric power to the filament. After being led out from the bottom of the light bulb 2, the lead wires 4 are bent horizontally to extend away from each other. The distal end portion of each lead wire 4 extends in a straight-line form. Each lead wire 4 is soldered to a pattern 6 (see FIG. 8) on a printed-wiring board 5, which is formed from a copper foil, whereby the indicator lamp 1 is mounted on the printed-wiring board 5, and electric power is supplied to the filament of the light bulb 2.

The above-described conventional indicator lamp has some problems as stated below.

(1) Because the lead wires 4 are soft as a whole and the distal end portion of each lead wire 4 extends in a straight-line form, it is difficult to ensure sufficiently high mechanical strength for the lead wires 4. Accordingly, the lead wires 4 cannot accurately be fixed in position and are readily deformable under application of small external force. For this reason, each lead wire 4 cannot reliably be brought into contact with solder on the pattern 6 formed on the printed-wiring board 5. Thus, a mounting failure is likely to occur.

(2) It is difficult to check the soldering quality of each lead wire 4 after the indicator lamp has been mounted on the printed-wiring board 5. FIG. 8 shows the state of the mounted indicator lamp when it is checked for solder defects. Because each lead wire 4 is a single wire, it is difficult to see the solder fillet for the soldering inspection. Accordingly, it is difficult to check the soldering quality of the lead wires 4.

(3) To perform soldering onto the printed-wiring board 5, the surfaces of the lead wires 4 are usually coated with solder by solder dipping. However, even if they are subjected to solder dipping, the lead wires 4 cannot reliably be connected to the patterns 6 on the printed-wiring board 5. FIG. 9 shows the lead wires 4 subjected to solder dipping. Because the lead wires 4 are straight, it often occurs that only the distal end portions 4a are coated with solder 7; it is rare that the other portions are coated with solder. The lead wires 4 that are coated with solder only at the distal end portions 4a cannot reliably be soldered to the patterns 6 on the printed-wiring board 5 because of an insufficient length for connection with each pattern 6. Therefore, a connection failure is likely to occur.

### SUMMARY OF THE INVENTION

The present invention was made in view of the above-described problems associated with the prior art. An object of the present invention is to provide an indicator lamp designed to allow the soldering quality of its lead wires as connected to respective patterns on a printed-wiring board to be checked effectively and easily and to permit the lead wires to be reliably soldered to the patterns on the printed-wiring board, thereby making it possible to ensure the reliability of mounting of the indicator lamp onto the printed-wiring board.

According to a first aspect of the present invention, there is provided an indicator lamp having an electric light bulb and lead wires led out from the light bulb. The lead wires are soldered to respective patterns on a printed-wiring board. The lead wires are structured to increase the effective area for soldering at the distal end portion of each lead wire.

According to a second aspect of the present invention, there is provided an indicator lamp having an electric light bulb and lead wires led out from the light bulb. The lead wires are soldered to respective patterns on a printed-wiring board. The leading end portions of the lead wires are looped.

According to a third aspect of the present invention, there is provided an indicator lamp having an electric light bulb and lead wires led out from the light bulb. The lead wires are soldered to respective patterns on a printed-wiring board. The leading end portions of the lead wires are folded back toward the light bulb.

According to the present invention, the distal end portions of the lead wires are looped or folded back, whereby necessary mechanical strength is imparted to the distal end portions of the lead wires. Therefore, the distal end portions of the lead wires are not readily deformable under application of external force. In addition, the lead wires can be accurately positioned with respect to the respective patterns on the printed-wiring board. Furthermore, because the distal end portion of each lead wire is lengthened, it is possible to ensure a sufficient length of solder coating for each lead wire when the lead wires are subjected to solder dipping. Accordingly, the lead wires can be reliably soldered to the patterns on the printed-wiring board. Thus, it is possible to ensure the reliability of mounting of the indicator lamp onto the printed-wiring board. Furthermore, the distal end portion of each lead wire is easy to see because it is looped or folded back. Accordingly, soldering check can be performed reliably.

The above and other objects, features and advantages of the present invention will become more apparent from the following description of the preferred embodiments thereof, taken in conjunction with the accompanying drawing.

### BRIEF DESCRIPTION OF THE DRAWING

FIGS. 1(a), 1(b) and 1(c) are plan, front and bottom views showing an indicator lamp according to a first embodiment of the present invention.

FIG. 2 is a sectional view taken along the line A-A in FIG. 1(b), showing the way in which the indicator lamp is mounted on a printed-wiring board.

FIG. 3 is a bottom view of an indicator lamp according to a second embodiment of the present invention.

FIG. 4 is a bottom view showing a distal end portion of a lead wire in a modification of the second embodiment of the present invention.

FIGS. 5(a) and 5(b) are front views showing another modification of the second embodiment of the present invention.

FIGS. 6(a), 6(b) and 6(c) are plan, front and bottom views showing a conventional indicator lamp.

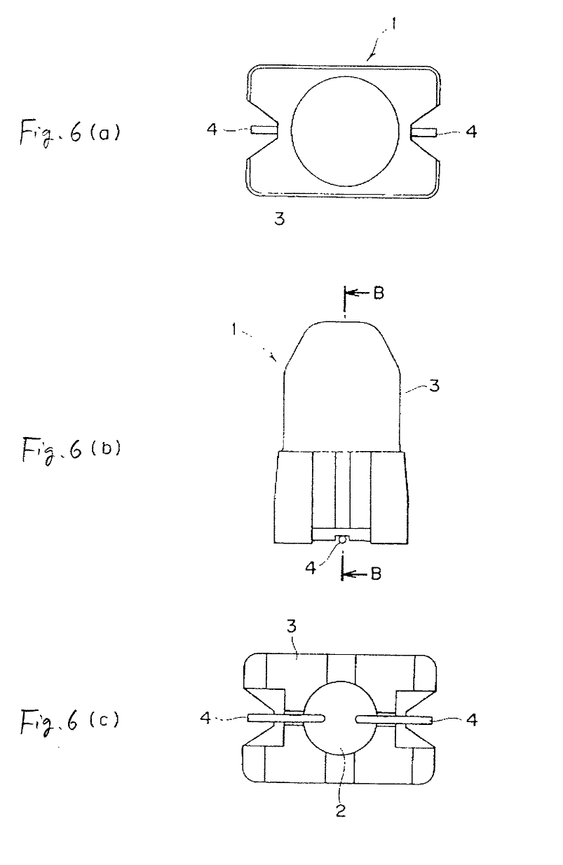

FIG. 7 is a sectional view taken along the line B-B in FIG. 6(b).

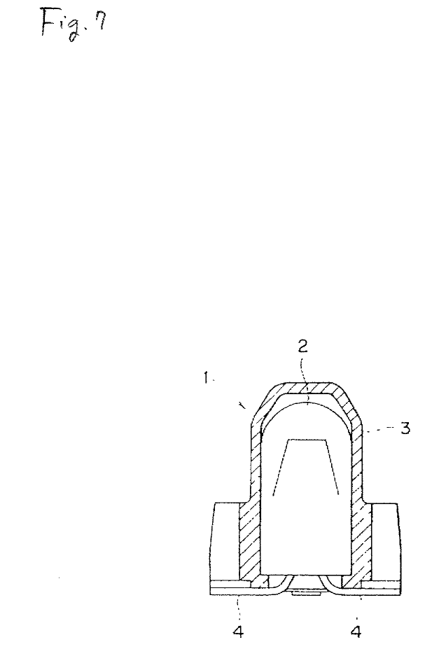

FIG. 8 is a perspective view showing the way in which the conventional indicator lamp is mounted on a printed-wiring board.

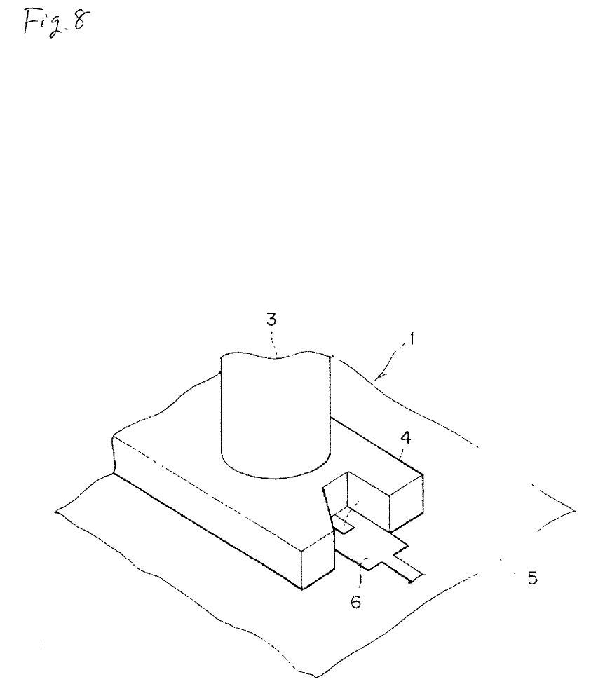

FIG. 9 is a front view showing lead wires of the conventional indicator lamp.

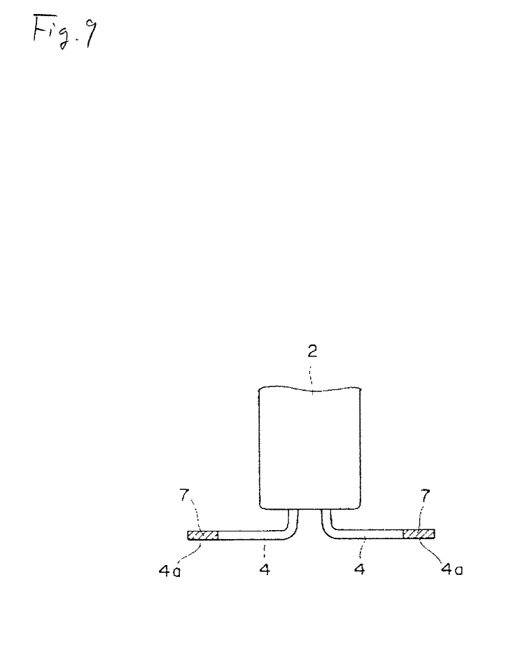

### DESCRIPTION OF THE PREFERRED EMBODIMENTS

The present invention will be described below more specifically by way of embodiments and with reference to the accompanying drawings. It should be noted that in each embodiment the same elements are denoted by the same reference numerals.

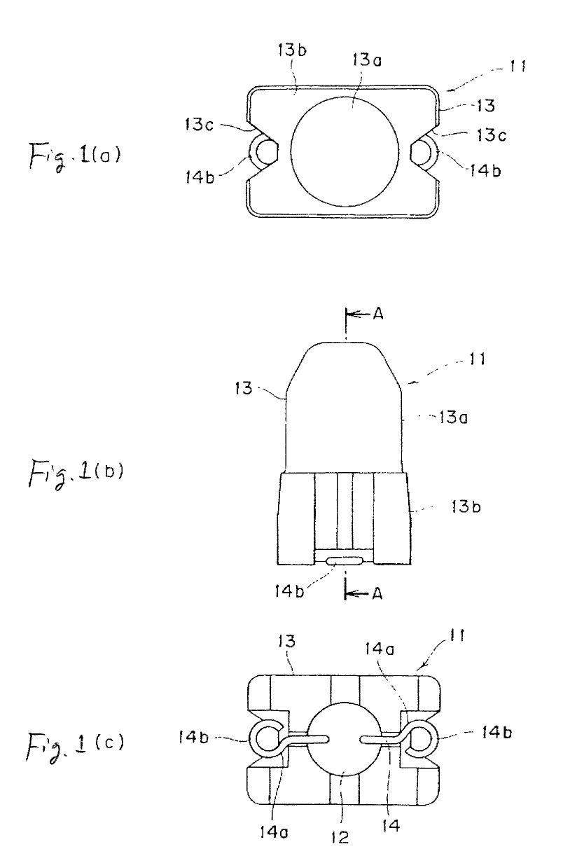

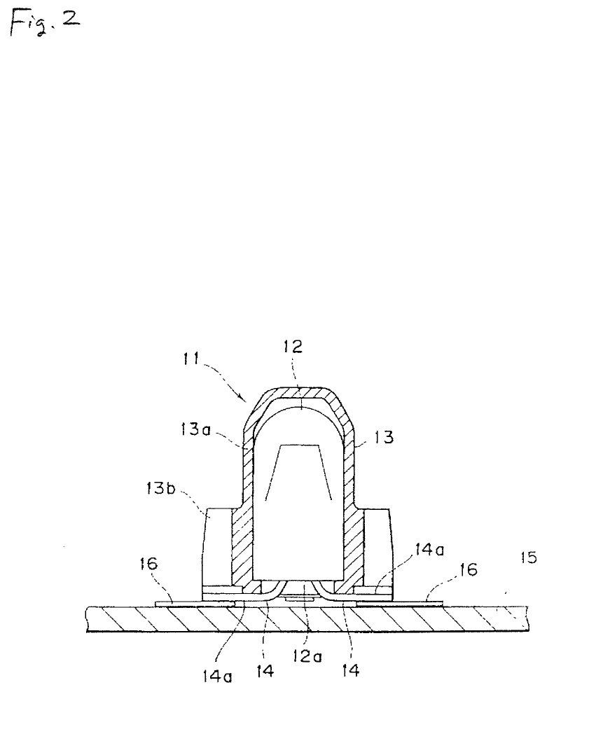

(First Embodiment) FIGS. 1(a), 1(b), 1(c) and 2 show a first embodiment of the present invention. An indicator lamp 11 according to this embodiment has an electric light bulb 12 and a housing 13. The indicator lamp 11 is incorporated in an air conditioner, a car stereo or an instrument panel mounted in a vehicle to indicate the operating status of such a car component or a gage.

The light bulb 12 contains a light-emitting device (not shown), e.g. a filament or a light-emitting diode. The housing 13 has an accommodating part 13a in the shape of a cylinder, the top of which is closed. The housing 13 further has a base part 13b extending sideward from the lower end portion of the accommodating part 13a. At least the accommodating part 13a is formed from a transparent material, e.g. a transparent plastic material. The light bulb 12 is inserted into the housing 13 from the bottom of the accommodating part 13a. The base part 13b has approximately V-shaped cut portions 13c at right and left ends thereof.

A pair of lead wires 14 are led out from the light bulb 12. After being led out from the bottom 12a of the light bulb 12, the lead wires 14 are bent horizontally away from each other. The lead wires 14 are connected by soldering to respective patterns 16 formed on a printed-wiring board 15.

As shown in FIGS. 1(a) and 1(c), each lead wire 14 in this embodiment is looped at a distal end portion 14a thereof to form a looped portion 14b. In this case, the looped portion 14b extends as far as the corresponding cut portion 13c of the base part 13b of the housing 13.

The surface of the distal end portion 14a of each lead wire 14, including the looped portion 14b, is coated with solder by solder dipping. After the solder dipping process, as shown in FIG. 2, each lead wire 14, including the looped portion 14b, is soldered to a pattern 16 formed on the printed-wiring board 15 from a copper foil or the like. Thus, electric power is supplied to the light-emitting device in the light bulb 12 through the patterns 16 and the lead wires 14. Therefore, the light bulb 12 can be lit up.

In this embodiment, necessary mechanical strength can be imparted to the distal end portions 14a of the lead wires 14 by forming the looped portions 14b at the distal end portions 14a. Accordingly, even if external force acts thereon, the distal end portions 14a will not readily be deformed. Therefore, the lead wires 14 can be accurately positioned with respect to the respective patterns 16 on the printed-wiring board 15. In addition, because the distal end portion 14a of each lead wire 14 has the looped portion 14b, it is possible to ensure a sufficient length of solder coating for each lead wire 14 when the lead wires 14 are subjected to solder dipping. Accordingly, the mechanical strength imparted to the distal end portions 14 and the sufficient length of solder coating allow the lead wires 14 to be reliably soldered to the patterns 16 on the printed-wiring board 15. Furthermore, because each lead wire 14 has a looped portion 14b at the distal end portion 14a, the solder fillet is easy to see. Accordingly, it is easy to check the soldering quality of the lead wires 14.

(Second Embodiment)

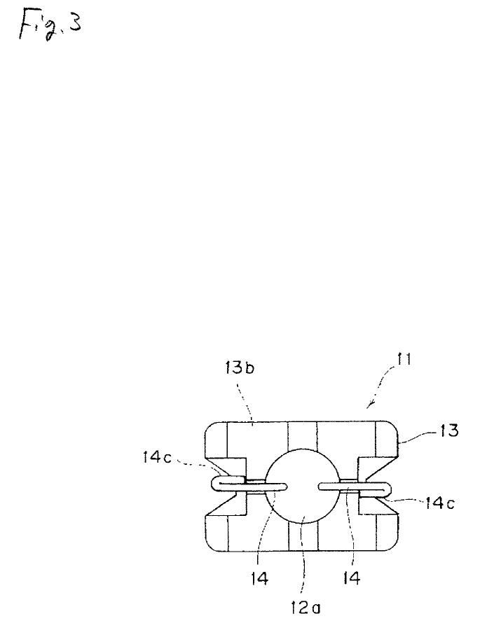

FIG. 3 shows a second embodiment of the present invention. In this embodiment, distal end portions 14a of a pair of lead wires 14 led out from the light bulb 12 are folded back toward the light bulb 12. Folded end portions 14c of the lead wires 14 are superimposed on the non-folded portions of the lead wires 14. In this case, the lead wires 14 are folded back in a horizontal plane. Folding the lead wires 14 in this way makes it possible to impart necessary mechanical strength to the distal end portions 14a and to ensure a sufficient length of solder coating for each lead wire 14 when the lead wires 14 are subjected to solder dipping. Accordingly, the second embodiment provides the same advantages as in the first embodiment.

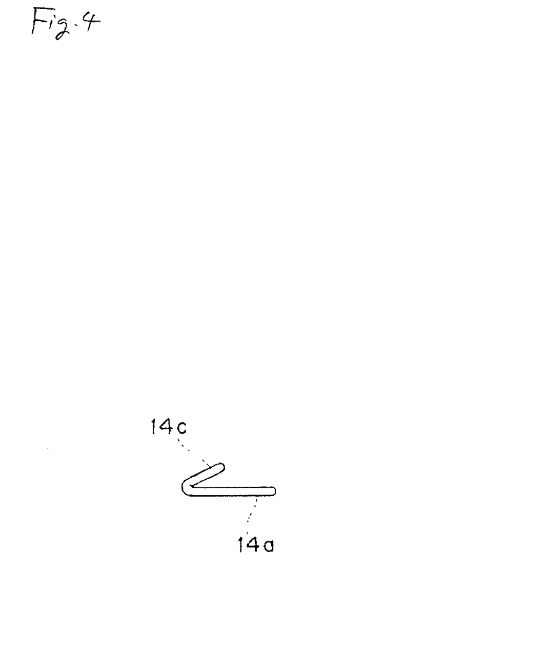

FIG. 4 shows a modification of the second embodiment. In the modification, the folded end portion 14c is at a predetermined angle to the non-folded portion. Accordingly, the folded end portion 14c is not superimposed on the non-folded portion. However, folding the distal end portion 14a in this way also makes it possible to impart necessary mechanical strength to the distal end portion 14a and to ensure a sufficient length of solder coating for each lead wire 14 when the lead wires 14 are subjected to solder dipping.

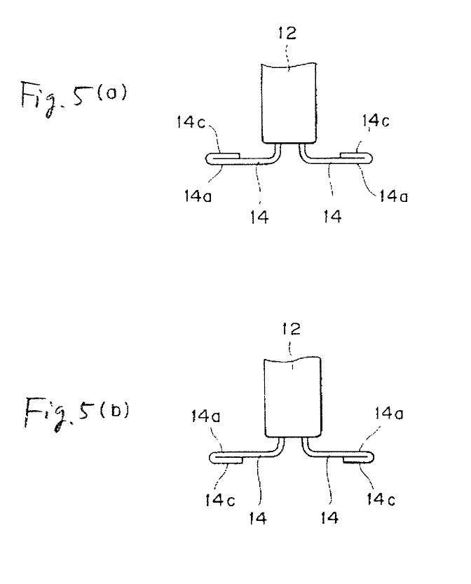

FIGS. 5(a) and 5(b) show another modification of the second embodiment. In FIG. 5(a), the folded end portion 14c of each lead wire 14 is superimposed on the upper side of the non-folded portion. In FIG. 5(b), the folded end portion 14c of each lead wire 14 is superimposed on the lower side of the non-folded portion. Even if the distal end portion 14a of each lead wire 14 is folded in either of the directions shown in FIGS. 5(a) and 5(b), it is possible to impart necessary mechanical strength to the distal end portion 14a and to ensure a sufficient length of solder coating for each lead wire 14 when the lead wires 14 are subjected to solder dipping.

As has been stated above, the indicator lamp according to the present invention has a structure in which the effective area for soldering is increased at the distal end portion of each lead wire, that is, the distal end portion of each lead wire is looped or folded back. Therefore, necessary mechanical strength is imparted to the distal end portion of each lead wire, so that the distal end portion is not readily deformable under application of external force. In addition, the lead wires can be accurately positioned with respect to the respective patterns on the printed-wiring board. Moreover, it is possible to ensure a sufficient length of solder coating for each lead wire when the lead wires are subjected to solder dipping. Accordingly, the lead wires can be reliably soldered to the patterns on the printed-wiring board. Thus, it is possible to ensure the reliability of mounting of the indicator lamp onto the printed-wiring board. Furthermore, because the distal end portion of each lead wire is easy to see, soldering check can be performed reliably.

It should be noted that the present invention is not necessarily limited to the foregoing embodiments but can be modified in a variety of ways without departing from the gist of the present invention.

What is claimed is:

1. An indicator lamp comprising:
an electric light bulb; and
lead wires led out from said electric light bulb, said lead wires being soldered to respective patterns on a printed-wiring board;
wherein said lead wires are structured to increase an effective area for soldering at a distal end portion of each of said lead wires.

2. An indicator lamp comprising:
an electric light bulb; and
lead wires led out from said electric light bulb, said lead wires being soldered to respective patterns on a printed-wiring board;
wherein leading end portions of said lead wires are looped.

3. An indicator lamp comprising:
an electric light bulb; and
lead wires led out from said electric light bulb, said lead wires being soldered to respective patterns on a printed-wiring board;
wherein leading end portions of said lead wires are folded back toward said electric light bulb.
